(19) United States
(12) Patent Application Publication
(10) Pub. No.: US 2013/0141458 A1
(43) Pub. Date: Jun. 6, 2013

(54) IMAGE PROCESSING DEVICE AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/559,562

(22) Filed: Jul. 26, 2012

(30) Foreign Application Priority Data
Dec. 2, 2011 (TW) 100144273

(51) Int. Cl. G09G 5/00

(52) U.S. Cl. 345/629

(57) ABSTRACT

An image processing device includes a storage module, an image obtaining module, a comparing module, and a processing module. The storage module stores a number of sample images, and feature information of each sample image. Each sample image includes one specific object. The image obtaining module retrieves an image to be processed. The comparing module determines whether feature information of one of the stored sample image matches with that of the obtained image. If feature information of one of the stored sample image matches with that of the obtained image, the processing module selects an area equal with the outline of the specific object in the obtained image, and adjusts the selected area to cause the selected area equal with the specific object of the obtained image.

### BACKGROUND

1. Technical Field

The present disclosure relates to image processing devices, and particularly, to an image processing device and a method for selecting an object in an image along an outline of the object and processing the selected object.

2. Description of Related Art

During processing an image using an image processing software, for example, Photoshop, if a user wants to select a specific object to edit, a lasso tool may be used to select an area along the outline of the object to isolate it from a background. However, by using the lasso tool, users have to manually operate the mouse to move the cursor along the outline of the object, which is inconvenient to operate.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of an image processing device in accordance with an exemplary embodiment.

FIG. 2 is a pictorial diagram illustrating the sample image and the image to be processed in accordance with an exemplary embodiment.

FIG. 3 is a flowchart of an image processing method in accordance with an exemplary embodiment.

### DETAILED DESCRIPTION

Embodiments of the present disclosure will now be described in detail, with reference to the accompanying drawings.

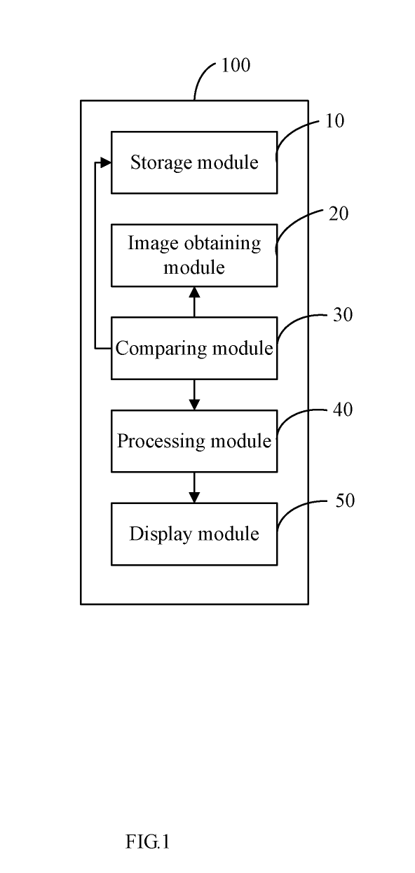

Referring to FIG. 1, in one embodiment, an image processing device 100 includes a storage module 10, an image obtaining module 20, a comparing module 30, a processing module 40, and a display module 50.

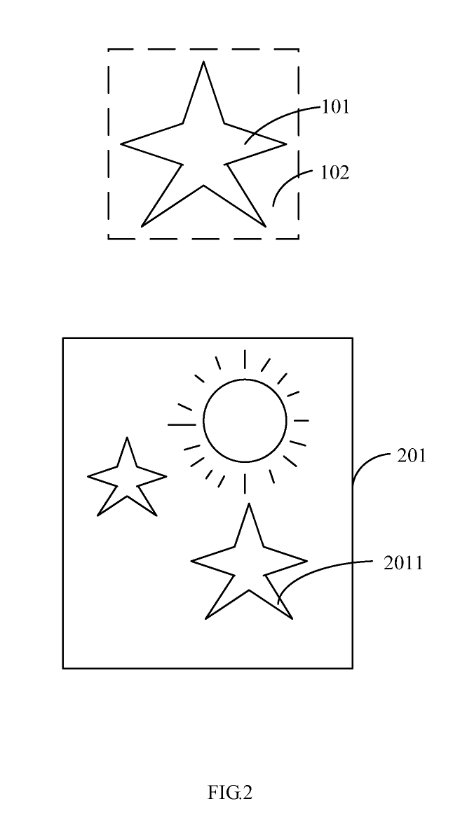

The storage module 10 stores a number of sample images 101, for example, shown in FIG. 2, each of the sample images includes one specific object, such as a star, a flower, a car, a human face, or the like, and a transparent background 102. Each of the objects can be identified by at least one special pixel area. In the embodiment, the at least one special pixel area can be determined by the color of the pixels. In detail, the pixels having a same color value may be identified as the special pixel area. In an alternative embodiment, the at least one special pixel area can be identified by the boundaries of the areas. In detail, a Sobel operator may be used to determine the boundaries in the image, and the area surrounded by a closed boundary may be identified as a special pixel area. The storage module 10 further stores feature information of each sample image 101. The feature information of each sample image 101 includes the position of the special pixel areas in the sample image 101. For example, if an sample image 101 includes a human face with black eyes, red lips, and brown skin, the areas of the eyes and the lips may be identified as the special pixel areas of the sample image 101, and the feature information of the sample image 101 is that the coordinate of the two eyes respectively are (30, 30) and (30, 60), the coordinate of the lips are (45, 10), the three special pixel areas positioned at the vertexes of a triangle.

The image obtaining module 20 is configured to obtain an image 201 to be processed in response to a user input. In the embodiment, the image to be processed includes at least one specific object 2011.

The comparing module 30 obtains feature information of the at least one specific object of the obtained the image 201 to be processed, compares the feature information of the at least one specific object 2011 of the obtained image 201 and the feature information of the specific object of the sample images 101 stored in the storage module 10, and determines whether feature information of the specific object of one of the stored sample image 101 matches with the feature information of the at least one specific object 2011. In the embodiment, if the special pixel areas of the obtained image 201 is the same as the special pixel areas of the stored sample image 101, and the position of the special pixel areas in the images are the same, it is determined that the feature information of the specific object 2011 of the obtained image matches with the feature information of the specific object of the stored sample image 101. For example, if an obtained image and a stored sample image 101 both includes a special pixel areas of human eyes and lips, and the positions of the human eyes and the lips in the image are the same, the comparing module 30 determines that the feature information of specific object of the obtained image is the same as the feature information of the specific object of the stored sample image 101.

If the comparing module 30 determines that the feature information of the specific object of one of the stored sample image 101 matches with the feature information of the specific object 2011 of the obtained image 201, the processing module 40 obtains the sample image 101 from the storage module 10 and determines a ratio of the size the specific object of the obtained image 201 to a size of the specific object of the sample image 101. In the embodiment, the processing module 40 determines the size of the images by determining the dimension of the special pixel areas, for example, if the distance between the two eyes of the obtained image is 70 pixels, and the distance between the two eyes of the sample image 101 is 30 pixels, the processing module 30 may determine the proportion of the size between the obtained image 201 and the sample image 101 is 7:3. The processing module 40 further adjusts the size of the sample image 101 such that the size of the specific object of the sample image 101 is the same as the specific object 2011 of the obtained image 201, and superposes the adjusted sample image 101 on the obtained image 201, with the special pixel area of the sample image 101 coinciding with the special pixel area of the obtained image 201. The specific object of the sample image 101 then covers the specific object 2011 of the obtained image 201. The processing module 40 further selects an area on the obtained image 201 along the outline of the sample image 101, and then removes the sample image 101 after the selection. In the embodiment, the processing module 40 further marks up the outline of the selected area to visually show the selected area to the user.

The processing module 40 further adjusts the selected area to cause the selected area to be substantially equal with the area of the specific object of the obtained image 201. The processing module 40 further edits the selected area in response to the user input.

If the comparing module 30 determines that no stored feature information of the specific object of sample image 101 matches with the feature information of the specific object of the obtained image 201, the processing module 40 informs the user to select the area manually.

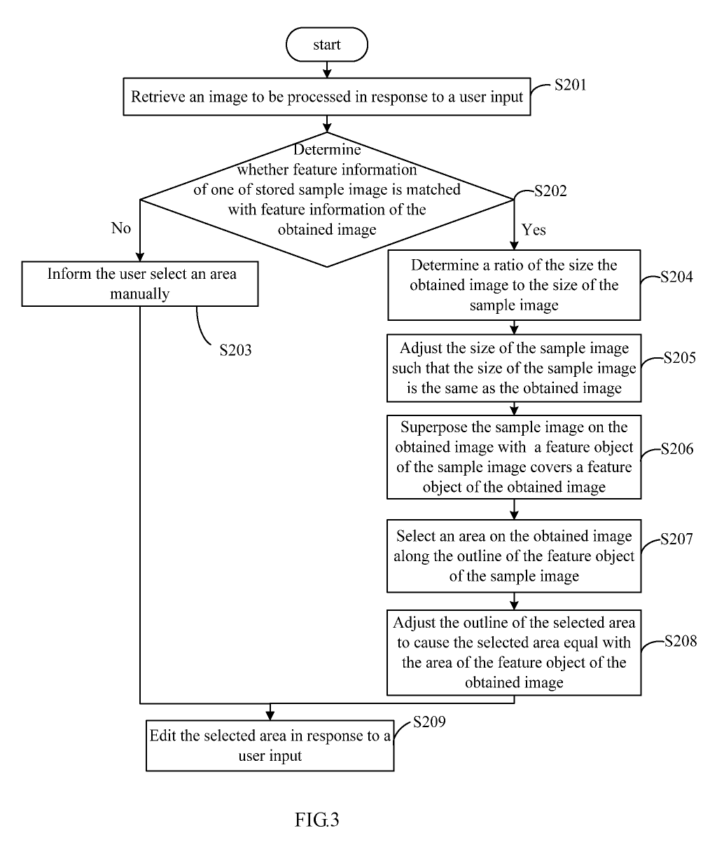

FIG. 3 is a flowchart of an image processing method in accordance with an exemplary embodiment.

In step S201, the image obtaining module 20 obtains an image 201 to be processed in response to a user input.

In step S202, the comparing module 30 obtains feature information of the at least one specific object 2011 of the obtained image 201, and compares the feature information of at least one specific object 2011 with the feature information of the specific object of the stored sample images 101 to determine whether feature information of the specific object of one of the stored sample image 101 matches with the feature information of the specific object 2011 of the obtained image 201, if no, the procedure goes to step S203, if yes, the procedure goes to step S204.

In step S203, the processing module 40 informs the user to select an area manually.

In step S204, the processing module 40 obtains the sample image 101 from the storage module 10 and determines a ratio of the size of the specific object 2011 of the obtained image 201 to the size of the specific object of the sample image 101.

In step S205, the processing module 40 adjusts the size of the specific object of the sample image 101 such that the size of specific object of the sample image 101 is the same as the specific object of the obtained image 201 to be processed.

In step S206, the processing module 40 superposes the adjusted sample image 101 on the obtained image 201, with the special pixel area of the sample image 101 coinciding with the special pixel area of the obtained image 201. The specific object of the sample image 101 then covers the specific object 2011 of the obtained image 201.

In step S207, the processing module 40 selects an area on the obtained image along the outline of the sample image 101, and then removes the sample image 101 after the selection. In the embodiment, the processing module 40 further marks up the outline of the selected area to visually show the selected area to the user.

In step S208, the processing module 40 adjusts the selected area to cause the selected area to be substantially equal with the area of the specific object of the obtained image 201.

In step S209, the processing module 40 further edits the selected area in response to the user input.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An image processing device comprising:
a display module;
a storage module storing a plurality of sample images, wherein each of the sample images comprises one specific object and a transparent background, the storage module further stores feature information of each sample image;
an image obtaining module to obtain an image to be processed in response to a user input, wherein the obtained image comprises at least one specific object;
a comparing module configured to:
obtain feature information of the at least one specific object of the obtained image; and
determine whether feature information of the specific object of one of the stored sample image matches with feature information of the at least one specific object of the obtained image; and
a processing module, wherein if the comparing module determines that the feature information of the specific object of one of the stored sample image matches with the feature information of the at least one specific object of the obtained image, the processing module obtains the sample image from the storage module, determines a ratio of a size of the specific object of the obtained image to a size of the specific object of the sample image, adjusts the size of the specific object of the sample image to be the same as the size of the specific object of the image to be processed, and superposes the adjusted sample image on the obtained image, with the specific object of the sample image coinciding with the specific object of the obtained image; the processing module further selects an area on the obtained image along an outline of the sample image, and then removes the sample image after the selection and adjusts the selected area to cause the selected area to be equal with the area of the specific object of the obtained image.

2. The image processing device as described in claim 1, wherein the processing image is further configured to edit the selected area in response to a user input.

3. The image processing device as described in claim 1, wherein each specific object is identified by at least one special pixel area, and the feature information of each sample image comprises positions of the special pixel areas in the sample image.

4. The image processing device as described in claim 3, wherein the at least one special pixel area is determined by colors of the pixels.

5. The image processing device as described in claim 3, wherein the at least one special pixel area is determined by the boundaries of the pixel areas.

6. The image processing device as described in claim 3, wherein the processing module determines the size of the images by determining the dimension of the special pixel areas.

7. The image processing device as described in claim 1, wherein if the comparing module determines that no stored feature information matches with the feature information of the obtained image, the processing module informs the user to select the area manually.

8. The image processing device as described in claim 1, wherein the processing module is further configured to mark up the outline of the selected area to visually show the selected area to the user.

9. An image processing method implemented by an image processing device, the processing device comprising a storage module storing a plurality of sample images, wherein each sample image comprise one specific object and a transparent background, the storage module further stores feature information of each sample image, the image processing method comprising:
obtaining an image to be processed in response to a user input;
obtaining feature information of at least one specific object of the obtained image, and determining whether feature information of the specific object one of the stored feature information matches with the feature information of the at least one specific object of the obtained image;
obtaining the sample image from the storage module and determining a ratio of a size of a specific object of the obtained image to a size of the specific object of the sample image if determining that the feature information of the specific object of one of the sample image matches with the feature information of the at least one specific object of obtained image;
adjusting the size of the specific object sample image to be the same as the size of the specific object of the obtained image;
superposing the adjusted sample image on the obtained image, with the specific object of the sample image coinciding with the specific object of the obtained image;
selecting an area on the obtained image along an outline of the sample image, and then removing the sample image after the selection;
adjusting the selected area to cause the selected area to be equal with the area of the specific object of the obtained image.

10. The image processing method as described in claim 9, further comprising:
editing the selected area in response to a user input.

11. The image processing method as described in claim 9, further comprising:
informing the user to select the area manually if determining that no stored feature information of the specific object of the sample image matches with the feature information of the at least one specific object of the obtained image.
